(19) United States
(12) Patent Application Publication
(10) Pub. No.: US 2017/0310819 A1
(43) Pub. Date: Oct. 26, 2017

(54) VOICE PLAY METHOD AND VOICE PLAY DEVICE

(71) Applicant: Huawei Technologies Co., Ltd., Shenzhen (CN)

(72) Inventors: Shunan FAN, Beijing (CN); Hong ZHANG, Shenzhen (CN); Wenmei GAO, Beijing (CN); Hao JING, Shenzhen (CN)

(21) Appl. No.: 15/526,284

(22) PCT Filed: Jan. 23, 2015
(86) PCT No.: PCT/CN2015/071384

§ 371 Date: May 11, 2017

(51) Int. Cl. H04M 3/06; H04W 4/14

(52) U.S. Cl. CPC H04M 3/06; H04W 4/14

(57) ABSTRACT

A voice play method includes: obtaining at least one piece of data information, and determining an information type of the at least one piece of data information; when it is determined that the voice play device is in a voice play mode, determining voice play content of the at least one piece of data information according to a specified correspondence between an information type and voice play content and the determined information type of the at least one piece of data information; and playing the voice play content of the at least one piece of data information in a voice manner.

### TECHNICAL FIELD

The present invention relates to the field of communications technologies, and in particular, to a voice play method and a voice play device.

### BACKGROUND

During use of a voice play device (for example, a smartphone, a smartwatch, or a tablet computer), the voice play device usually receives some notification messages.

For example, that a communications peer end sends an SMS message to the voice play device includes that the communications peer end sends the SMS message to a network side, and then the network side sends the SMS message to the voice play device. When receiving the SMS message, the voice play device displays, in a message bar, a notification message used to indicate that the SMS message is received, and the notification message is used to notify a user using the voice play device that the SMS message is received.

For another example, a particular application client is installed in the voice play device, and a network-side server corresponding to the application client sends a notification message to the application client. For example, the notification message may be chat information, news information, or system update prompt information. When receiving the notification message, the voice play device displays the notification message in a message bar, and the notification message is used to notify a user using the voice play device that a message of the application client is received.

The voice play device generally prompts, in a manner of vibrating or ringing, the user using the voice play device with the notification message displayed in the message bar. In this case, the user using the voice play device needs to manually start the voice play device to view the received SMS message or application client information, to learn information content corresponding to the notification message; and determine whether the received SMS message or application client information needs to be viewed and processed in a timely manner.

With the development of technologies, a manner of automatic text to voice play is proposed, that is, a received text is directly played in a voice manner by using assistant software or hardware (for example, a Bluetooth headset, Microsoft's Cortana, or Apple's Siri).

A prerequisite for the manner of automatic text to voice play is that the user using the voice play device needs to trigger an action of unlocking the voice play device, and trigger an instruction of listening to voice play converted from a text, to automatically play the received SMS message or application client information.

In an actual application, when the user using the voice play device currently cannot send an operation instruction to the voice play device, for example, it is inconvenient for the user to view the notification message during driving, running, or walking, the user cannot obtain any content of the received SMS message or application client information. Alternatively, in an actual application, information content (such as advertisement information or a junk SMS message) corresponding to a directly played notification message is not necessarily information that the user needs to immediately view, and in this case, text to voice play is a disturbance to the user, and may have adverse impact on behavior that is being triggered by the user (for example, affect driving safety).

It is obvious that, a currently used manner of text to voice play generally requires a manual user operation, causing a relatively undiversified message processing manner, and poor user experience.

### SUMMARY

In view of this, embodiments of the present invention provide a voice play method and a voice play device, so that corresponding content can be played according to an information type, which enhances an interaction capability of the voice play device.

According to a first aspect, a voice play method is provided, applied to a voice play device, and including:

obtaining at least one piece of data information, and determining an information type of the at least one piece of data information;

determining, by the voice play device, voice play content of the at least one piece of data information according to a specified correspondence between an information type and voice play content and the determined information type of the at least one piece of data information; and

playing the voice play content of the at least one piece of data information in a voice manner.

With reference to the first aspect, in a first possible implementation manner of the first aspect, the at least one piece of data information is at least two pieces of data information;

before the playing the voice play content of the at least one piece of data information in a voice manner, the method further includes:

if the at least two pieces of data information are separately data information having different information types, determining a first voice play order of the at least two pieces of data information according to specified voice play orders of data information having different information types; and

the playing the voice play content of the at least one piece of data information in a voice manner includes:

playing, in the voice manner according to the first voice play order, voice play content of each of the at least two pieces of data information having different information types.

With reference to the first aspect, in a second possible implementation manner of the first aspect, the at least one piece of data information is at least two pieces of data information;

before the playing the voice play content of the at least one piece of data information in a voice manner, the method further includes:

if the at least two pieces of data information have a same information type, determining a second voice play order of the at least two pieces of data information according to specified voice play orders of data information having a same information type; and the playing the voice play content of the at least one piece of data information in a voice manner includes:

playing voice play content of each of the at least two pieces of data information in the voice manner according to the second voice play order.

With reference to the first aspect, in a third possible implementation manner of the first aspect, the at least one piece of data information is at least two pieces of data information;

before the playing the voice play content of the at least one piece of data information in a voice manner, the method further includes:

if a quantity of information types of the at least two pieces of data information is greater than 1, and a quantity of pieces of data information having a same information type is greater than 1, respectively determining a second voice play order and a first voice play order of the at least two pieces of data information according to specified voice play orders of data information having a same information type and specified voice play orders of data information having different information types; and the playing the voice play content of the at least one piece of data information in a voice manner includes:

playing voice play content of each of the at least two pieces of data information in the voice manner according to the first voice play order and the second voice play order.

With reference to the first aspect, or with reference to the first possible implementation manner of the first aspect, or with reference to the second possible implementation manner of the first aspect, or with reference to the third possible implementation manner of the first aspect, in a fourth possible implementation manner of the first aspect, the voice play content of the at least one piece of data information includes source information of the at least one piece of data information;

before the playing the voice play content of the at least one piece of data information in a voice manner, the method further includes:

determining, according to the source information of the at least one piece of data information, whether the at least one piece of data information is allowed to play; and

the playing the voice play content of the at least one piece of data information in a voice manner includes:

playing the voice play content of the at least one piece of data information in the voice manner when determining that the at least one piece of data information is allowed to play.

With reference to the fourth possible implementation manner of the first aspect, in a fifth possible implementation manner of the first aspect, the method further includes: when determining that the at least one piece of data information is forbidden to play, prompting, in a manner of ringing or vibrating, with the at least one piece of data information that is forbidden to play.

With reference to the first aspect, or with reference to the first possible implementation manner of the first aspect, or with reference to the second possible implementation manner of the first aspect, or with reference to the third possible implementation manner of the first aspect, or with reference to the fourth possible implementation manner of the first aspect, or with reference to the fifth possible implementation manner of the first aspect, in a sixth possible implementation manner of the first aspect, if the information type of the at least one piece of data information is an SMS message, voice play content corresponding to the SMS message includes at least one of source information or data information content; or

if the information type of the at least one piece of data information is an application client, voice play content corresponding to the application client includes at least one of source information, a data information keyword, or data information content.

With reference to the first aspect, or with reference to the first possible implementation manner of the first aspect, or with reference to the second possible implementation manner of the first aspect, or with reference to the third possible implementation manner of the first aspect, or with reference to the fourth possible implementation manner of the first aspect, or with reference to the fifth possible implementation manner of the first aspect, in a seventh possible implementation manner of the first aspect, if the information type of the at least one piece of data information is a text, voice play content corresponding to the text includes at least one of text content or keyword content of text content; or

if the information type of the at least one piece of data information is an audio type or a video type, voice play content corresponding to the audio type or the video type includes audio content; or

if the information type of the at least one piece of data information is an image, voice play content corresponding to the image includes content displayed in the image; or

if the information type of the at least one piece of data information is a link, voice play content corresponding to the link type includes a link address.

With reference to the seventh possible implementation manner of the first aspect, in an eighth possible implementation manner of the first aspect, the content displayed in the image is determined in the following manner:

determining a category of an object displayed in the image, where the category of the object includes at least one of a person, scenery, an animal, a plant, or an article;

determining, according to the category of the object and a specified correspondence between the category of the object and a keyword of the object, the keyword corresponding to the object displayed in the image; and determining the keyword as the content displayed in the image.

With reference to the first aspect, or with reference to the first possible implementation manner of the first aspect, or with reference to the second possible implementation manner of the first aspect, or with reference to the third possible implementation manner of the first aspect, or with reference to the fourth possible implementation manner of the first aspect, or with reference to the fifth possible implementation manner of the first aspect, or with reference to the sixth possible implementation manner of the first aspect, or with reference to the seventh possible implementation manner of the first aspect, or with reference to the eighth possible implementation manner of the first aspect, in a ninth possible implementation manner of the first aspect, the method further includes:

when the voice play content of the at least one piece of data information is played in the voice manner, if new data information is obtained, obtaining an information type of the new data information and voice play content of the new data information;

determining a third voice play order of data information being played, to-be-played data information, and the new data information according to the specified voice play orders having different information types and/or the specified voice play orders of data information having a same information type; and

playing voice play content of the data information being played, voice play content of the to-be-played data information, and the voice play content of the new data information in the voice manner according to the determined third voice play order.

According to a second aspect, a voice play device is provided, including:

an obtaining unit, configured to obtain at least one piece of data information;

a determining unit, configured to: determine an information type of the at least one piece of data information obtained by the obtaining unit, and determine voice play content of the at least one piece of data information according to a specified correspondence between an information type and voice play content and the determined information type of the at least one piece of data information; and

a play unit, configured to play the voice play content of the at least one piece of data information in a voice manner.

With reference to the second aspect, in a first possible implementation manner of the second aspect, the at least one piece of data information is at least two pieces of data information;

the voice play device further includes a play order determining unit, where

the play order determining unit is configured to: before the voice play content of the at least one piece of data information is played in the voice manner, if the at least two pieces of data information are separately data information having different information types, determine a first voice play order of the at least two pieces of data information according to specified voice play orders of data information having different information types; and

the play unit is specifically configured to play, in the voice manner according to the first voice play order, voice play content of each of the at least two pieces of data information having different information types.

With reference to the second aspect, in a second possible implementation manner of the second aspect, the at least one piece of data information is at least two pieces of data information;

the voice play device further includes a play order determining unit, where

the play order determining unit is configured to: if the at least two pieces of data information have a same information type, determine a second voice play order of the at least two pieces of data information according to specified voice play orders of data information having a same information type; and

the play unit is specifically configured to play voice play content of each of the at least two pieces of data information in the voice manner according to the second voice play order.

With reference to the second aspect, in a third possible implementation manner of the second aspect, the at least one piece of data information is at least two pieces of data information;

the voice play device further includes a play order determining unit, where

the play order determining unit is configured to: before the voice play content of the at least one piece of data information is played in the voice manner, if a quantity of information types of the at least two pieces of data information is greater than 1, and a quantity of pieces of data information having a same information type is greater than 1, respectively determine a second voice play order and a first voice play order of the at least two pieces of data information according to specified voice play orders of data information having a same information type and specified voice play orders of data information having different information types; and

the play unit is specifically configured to play voice play content of each of the at least two pieces of data information in the voice manner according to the first voice play order and the second voice play order.

With reference to the second aspect, or with reference to the first possible implementation manner of the second aspect, or with reference to the second possible implementation manner of the second aspect, or with reference to the third possible implementation manner of the second aspect, in a fourth possible implementation manner of the second aspect, the voice play content of the at least one piece of data information includes source information of the at least one piece of data information;

the voice play device further includes a judging unit, where

the judging unit is configured to: before the voice play content of the at least one piece of data information is played in the voice manner, determine, according to a correspondence of the source information of the at least one piece of data information, whether the at least one piece of data information is allowed to play; and

the play unit is specifically configured to play the voice play content of the at least one piece of data information in the voice manner when it is determined that the at least one piece of data information is allowed to play.

With reference to the fourth possible implementation manner of the second aspect, in a fifth possible implementation manner of the second aspect, the voice play device further includes a notification unit, where

the notification unit is configured to: when it is determined that the at least one piece of data information is forbidden to play, prompt, in a manner of ringing or vibrating, with the at least one piece of data information that is forbidden to play.

With reference to the second aspect, or with reference to the first possible implementation manner of the second aspect, or with reference to the second possible implementation manner of the second aspect, or with reference to the third possible implementation manner of the second aspect, or with reference to the fourth possible implementation manner of the second aspect, or with reference to the fifth possible implementation manner of the second aspect, in a sixth possible implementation manner of the second aspect, if the information type of the at least one piece of data information is an SMS message, voice play content corresponding to the SMS message includes at least one of source information or data information content; or

if the information type of the at least one piece of data information is an application client, voice play content corresponding to the application client includes at least one of source information, a data information keyword, or data information content.

With reference to the second aspect, or with reference to the first possible implementation manner of the second aspect, or with reference to the second possible implementation manner of the second aspect, or with reference to the third possible implementation manner of the second aspect, or with reference to the fourth possible implementation manner of the second aspect, or with reference to the fifth possible implementation manner of the second aspect, in a seventh possible implementation manner of the second aspect, if the information type of the at least one piece of data information is a text, voice play content corresponding to the text includes at least one of text content or keyword content of text content; or

if the information type of the at least one piece of data information is an audio type or a video type, voice play content corresponding to the audio type or the video type includes audio content; or

if the information type of the at least one piece of data information is an image, voice play content corresponding to the image includes content displayed in the image; or

if the information type of the at least one piece of data information is a link, voice play content corresponding to the link type includes a link address.

With reference to the seventh possible implementation manner of the second aspect, in an eighth possible implementation manner of the second aspect, the content displayed in the image is determined in the following manner:

determining a category of an object displayed in the image, where the category of the object includes at least one of a person, scenery, an animal, a plant, or an article;

determining, according to the category of the object and a specified correspondence between the category of the object and a keyword of the object, the keyword corresponding to the object displayed in the image; and

determining the keyword as the content displayed in the image.

With reference to the second aspect, or with reference to the first possible implementation manner of the second aspect, or with reference to the second possible implementation manner of the second aspect, or with reference to the third possible implementation manner of the second aspect, or with reference to the fourth possible implementation manner of the second aspect, or with reference to the fifth possible implementation manner of the second aspect, or with reference to the sixth possible implementation manner of the second aspect, or with reference to the seventh possible implementation manner of the second aspect, or with reference to the eighth possible implementation manner of the second aspect, in a ninth possible implementation manner of the second aspect, the obtaining unit is further configured to: when the voice play content of the at least one piece of data information is played in the voice manner, if new data information is obtained, obtain an information type of the new data information and voice play content of the new data information;

the play order unit is further configured to determine a third voice play order of data information being played, to-be-played data information, and the new data information according to the specified voice play orders having different information types and/or the specified voice play orders of data information having a same information type; and

the play unit is configured to play voice play content of the data information being played, voice play content of the to-be-played data information, and the voice play content of the new data information in the voice manner according to the determined third voice play order.

According to a third aspect, a voice play device is provided, including:

a transceiver, configured to obtain at least one piece of data information;

a processor, configured to: determine an information type of the at least one piece of data information, and determine voice play content of the at least one piece of data information according to a specified correspondence between an information type and voice play content and the determined information type of the at least one piece of data information; and

a voice output module, configured to play the voice play content of the at least one piece of data information in a voice manner.

With reference to the third aspect, in a first possible implementation manner of the third aspect, the at least one piece of data information is at least two pieces of data information;

before the voice output module plays the voice play content of the at least one piece of data information in the voice manner, the processor is further configured to:

if the at least two pieces of data information are separately data information having different information types, determine a first voice play order of the at least two pieces of data information according to specified voice play orders of data information having different information types; and

that the voice output module plays the voice play content of the at least one piece of data information in the voice manner specifically includes:

playing, in the voice manner according to the first voice play order, voice play content of each of the at least two pieces of data information having different information types.

With reference to the third aspect, in a second possible implementation manner of the third aspect, the at least one piece of data information is at least two pieces of data information;

before the voice output module plays the voice play content of the at least one piece of data information in the voice manner, the processor is further configured to:

if the at least two pieces of data information have a same information type, determine a second voice play order of the at least two pieces of data information according to specified voice play orders of data information having a same information type; and

that the voice output module plays the voice play content of the at least one piece of data information in the voice manner specifically includes:

playing voice play content of each of the at least two pieces of data information in the voice manner according to the second voice play order.

With reference to the third aspect, in a third possible implementation manner of the third aspect, the at least one piece of data information is at least two pieces of data information;

before the voice output module plays the voice play content of the at least one piece of data information in the voice manner, the processor is further configured to:

if a quantity of information types of the at least two pieces of data information is greater than 1, and a quantity of pieces of data information having a same information type is greater than 1, respectively determine a second voice play order and a first voice play order of the at least two pieces of data information according to specified voice play orders of data information having a same information type and specified voice play orders of data information having different information types; and

that the voice output module plays the voice play content of the at least one piece of data information in the voice manner specifically includes:

playing voice play content of each of the at least two pieces of data information in the voice manner according to the first voice play order and the second voice play order.

With reference to the third aspect, or with reference to the first possible implementation manner of the third aspect, or with reference to the second possible implementation manner of the third aspect, or with reference to the third possible implementation manner of the third aspect, in a fourth possible implementation manner of the third aspect, the voice play content of the at least one piece of data information includes source information of the at least one piece of data information;

before the voice output module plays the voice play content of the at least one piece of data information in the voice manner, the processor is further configured to:

determine, according to a correspondence of the source information of the at least one piece of data information, whether the at least one piece of data information is allowed to play; and

that the voice output module plays the voice play content of the at least one piece of data information in the voice manner specifically includes:

playing the voice play content of the at least one piece of data information in the voice manner when it is determined that the at least one piece of data information is allowed to play.

With reference to the fourth possible implementation manner of the third aspect, in a fifth possible implementation manner of the third aspect, the processor is further configured to:

when it is determined that the at least one piece of data information is forbidden to play, prompt, in a manner of ringing or vibrating, with the at least one piece of data information that is forbidden to play.

With reference to the third aspect, or with reference to the first possible implementation manner of the third aspect, or with reference to the second possible implementation manner of the third aspect, or with reference to the third possible implementation manner of the third aspect, or with reference to the fourth possible implementation manner of the third aspect, or with reference to the fifth possible implementation manner of the third aspect, in a sixth possible implementation manner of the third aspect, if the information type of the at least one piece of data information is an SMS message, voice play content corresponding to the SMS message includes at least one of source information or data information content; or

if the information type of the at least one piece of data information is an application client, voice play content corresponding to the application client includes at least one of source information, a data information keyword, or data information content.

With reference to the third aspect, or with reference to the first possible implementation manner of the third aspect, or with reference to the second possible implementation manner of the third aspect, or with reference to the third possible implementation manner of the third aspect, or with reference to the fourth possible implementation manner of the third aspect, or with reference to the fifth possible implementation manner of the third aspect, in a seventh possible implementation manner of the third aspect, if the information type of the at least one piece of data information is a text, voice play content corresponding to the text includes at least one of text content or keyword content of text content; or

if the information type of the at least one piece of data information is an audio type or a video type, voice play content corresponding to the audio type or the video type includes audio content; or

if the information type of the at least one piece of data information is an image, voice play content corresponding to the image includes content displayed in the image; or

if the information type of the at least one piece of data information is a link, voice play content corresponding to the link type includes a link address.

With reference to the seventh possible implementation manner of the third aspect, in an eighth possible implementation manner of the third aspect, the content displayed in the image is determined in the following manner:

determining a category of an object displayed in the image, where the category of the object includes at least one of a person, scenery, an animal, a plant, or an article;

determining, according to the category of the object and a specified correspondence between the category of the object and a keyword of the object, the keyword corresponding to the object displayed in the image; and

determining the keyword as the content displayed in the image.

With reference to the third aspect, or with reference to the first possible implementation manner of the third aspect, or with reference to the second possible implementation manner of the third aspect, or with reference to the third possible implementation manner of the third aspect, or with reference to the fourth possible implementation manner of the third aspect, or with reference to the fifth possible implementation manner of the third aspect, or with reference to the sixth possible implementation manner of the third aspect, or with reference to the seventh possible implementation manner of the third aspect, or with reference to the eighth possible implementation manner of the third aspect, in a ninth possible implementation manner of the third aspect, the processor is further configured to: when the voice play content of the at least one piece of data information is played in the voice manner, if new data information is obtained, obtain an information type of the new data information and voice play content of the new data information; and determine a third voice play order of data information being played, to-be-played data information, and the new data information according to the specified voice play orders having different information types and/or the specified voice play orders of data information having a same information type; and

the voice output module is further configured to play voice play content of the data information being played, voice play content of the to-be-played data information, and the voice play content of the new data information in the voice manner according to the determined third voice play order.

In the embodiments of the present invention, at least one piece of data information is obtained, and an information type of the at least one piece of data information is determined; the voice play device determines voice play content of the at least one piece of data information according to a specified correspondence between an information type and voice play content and the determined information type of the at least one piece of data information; and the voice play content of the at least one piece of data information is played in a voice manner. In this way, when a voice play device is in a voice play mode, for obtained data information, the voice play device may play corresponding content according to an information type of the data information, which enhances an interaction capability of the voice play device, and brings good device experience to a user of the voice play device.

### BRIEF DESCRIPTION OF DRAWINGS

To describe the technical solutions in the embodiments of the present invention more clearly, the following briefly describes the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 is a schematic flowchart of a voice play method according to Embodiment 1 of the present invention;

FIG. 2 is a schematic flowchart of a voice play method according to Embodiment 2 of the present invention;

FIG. 3 is a schematic flowchart of a voice play method according to Embodiment 3 of the present invention;

FIG. 4 is a schematic structural diagram of a voice play device according to Embodiment 4 of the present invention; and

FIG. 5 is a schematic structural diagram of a voice play device according to Embodiment 5 of the present invention.

### DESCRIPTION OF EMBODIMENTS

To achieve the objective of the present invention, embodiments of the present invention provide a voice play method and a voice play device. When a voice play device is in a voice play mode, for obtained data information, the voice play device may play corresponding content according to an information type of the data information. This simplifies an operation procedure of a user of the voice play device in a data information obtaining process, enhances an interaction capability of the voice play device, and brings good device experience to the user of the voice play device.

A voice play device in the embodiments of the present invention may refer to any mobile or portable electronic device that has an information identification capability or a voice play capability, and includes but is not limited to a mobile phone, a mobile computer, a tablet computer, a personal digital assistant (English: Personal Digital Assistant, Abbreviation: PDA), a media player, a smart television, a wearable voice play device, a combination of the foregoing at least two device functions, or the like.

In the embodiments of the present invention, data information may refer to information or a message that is sent by a network side or forwarded by a network side and is received by a voice play device, or may be voice information or digital information; or may be information, in any form, that is from a voice play device itself and is used to prompt a user of the voice play device, for example, an application notification message, a system update message, an SMS message from an SMS message center, prompt information that is generated by an operating system of the voice play device and is for prompting the user of the voice play device, missed call information, electricity amount information of the voice play device, network connection information, news information, or any combination of the foregoing information.

In the embodiments of the present invention, an information type of data information may be classified into call information, an SMS message, application client information, and the like according to different devices that send the data information. For example, the SMS message is sent by an SMS message center server on a network side; the call information is sent by a mobility management entity (English: Mobile Management Entity, Abbreviation: MME) on a network side; or the application client information is sent by an application server on a network side. Alternatively, an information type of data information may be classified into text information, image information, audio information, video information, and the like according to different presentation forms of the data information.

In the embodiments of the present invention, data information content refers to specific content that is included in data information and that a user of a voice play device is expected to obtain or perceive, for example, text information or image information included in an SMS message; or audio information or video information that is in an application client and is sent by a communications peer.

In the embodiments of the present invention, a data information keyword refers to key information that is extracted from data information content and can reflect the data information content, for example, headline information of news pushed by a news application, or a keyword in text information included in an SMS message.

In the embodiments of the present invention, source information of data information refers to information about a sending party of the data information, for example, the source information may refer to an identifier of the sending party of the data information, a telephone number of the sending party of the data information, an application client identifier of the sending party of the data information, or an IP address of the sending party of the data information.

In the embodiments of the present invention, a voice play mode refers to a mode in which data information obtained by a voice play device is played in a voice manner. After the voice play mode is enabled, the data information obtained by the voice play device is played in the voice manner by using an audio transmission module such as a headset (or a Bluetooth headset) or a speaker. A manner of whether to enable the voice play mode may be selected by a user of the voice play device, or the voice play mode may be enabled by means of triggering when a headset jack of the voice play device is connected to a headset device, or the like, which is not limited in the embodiments of the present invention.

In the embodiments of the present invention, voice play content of data information refers to content, of the data information, that needs to be played in a voice manner. Voice play content is corresponding to an information type of data information, and corresponding voice play content varies with a type of data information. For example, voice play content corresponding to an SMS message may include an identifier of a communications peer that sends the SMS message, and content of the SMS message; or voice play content corresponding to application client information may include an identifier of a communications peer that sends an SMS message, a keyword of the application client information, and content of the application client information.

In the embodiments of the present invention, a voice play order of data information refers to a play order, during play in a voice manner, that is determined according to an information type. For example, the voice play orders having different information types are set according to a use habit of a user of the voice play device, or are manually set by a user of the voice play device; and the voice play orders of different data information having a same information type are set according to a use habit of a user of the voice play device, or are manually set by a user of the voice play device.

In the embodiments of the present invention, to-be-played data information means that after received data information is sorted or is written into a voice play sequence according to a determined voice play order, and during data information play in a voice manner, if data information that is currently being played is referred to as data information being played, data information that is still not in a play state is referred to as the to-be-played data information according to the voice play order.

In the embodiments of the present invention, some junk information or harassment information exists in received data information, and if data information belongs to the junk information or the harassment information, when the data information is received, there is no need to play the data information to a user of a voice play device in a voice manner. Therefore, received data information that belongs to the junk information or the harassment information may be filtered out, to ensure that data information played to the user of the voice play device in the voice manner belongs to non-junk information or non-harassment information.

In the embodiments of the present invention, a network-side device includes but is not limited to various network element devices on a network side, for example, a service server, a gateway device, a proxy server, a wireless local area network device, a WiFi hotspot device, and a near field communication device.

The following further describes the embodiments of the present invention in detail with reference to the accompanying drawings of the specification. Apparently, the described embodiments are merely some but not all of the embodiments of the present invention. All other embodiments obtained by a person of ordinary skill in the art based on the embodiments of the present invention without creative efforts shall fall within the protection scope of the present invention.

### Embodiment 1

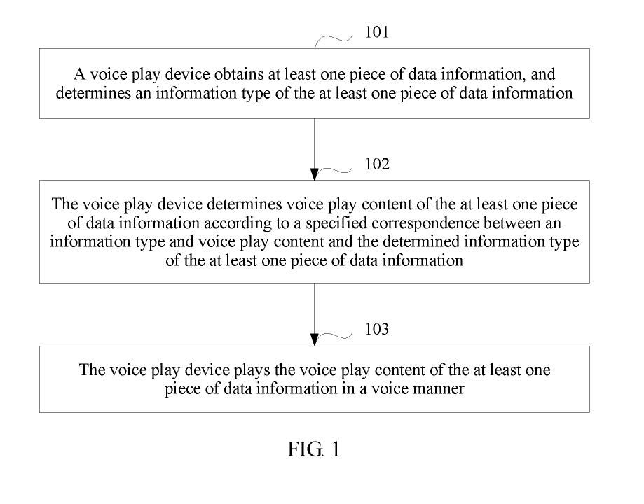

As shown in FIG. 1, FIG. 1 is a schematic flowchart of a voice play method according to Embodiment 1 of the present invention. This embodiment of the present invention may be executed by a voice play device, or may be executed by another device having a function of a voice play device, and that this embodiment of the present invention is executed by the voice play device is used herein for description. The method may be described as follows.

Step 101: The voice play device obtains at least one piece of data information, and determines an information type of the at least one piece of data information.

Optionally, in step 101, the voice play device obtains the at least one piece of data information from a network-side device. The at least one piece of data information may be directly sent by the network-side device to the voice play device, or may be forwarded by the network-side device to the voice play device when the network-side device receives the at least one piece of data information, and how to obtain the data information is not specifically limited herein.

The data information obtained by the voice play device includes at least one of call information, an SMS message, application client information, or operating system update information.

Optionally, if the data information sent by the network-side device is call information, when receiving the call information sent by the network-side device, the voice play device determines that an information type of the received call information is a call type.

Optionally, if the data information sent by the network-side device is an SMS message, when receiving the SMS message sent by the network-side device, the voice play device determines that an information type of the received SMS message is an SMS message type.

Optionally, if the data information sent by the network-side device is application client information, when receiving the application client information sent by the network-side device, the voice play device determines that an information type of the received application client information is an application client type.

Optionally, if the data information sent by the network-side device is operating system update information, when receiving the operating system update information sent by the network-side device, the voice play device determines that an information type of received application client information is a system update type.

It should be noted that, call-type data information may be call information forwarded by a network side, and after the voice play device obtains the call information, the voice play device processes the call information, and further determines whether the call information belongs to missed call information, or belongs to rejected call information, or belongs to call information on which a call transfer operation needs to be performed, or the like.

The application client type may be further classified. For example, the application client type is classified into a chat application client, a news application client, and a game application client according to a function of an application client. For another example, the application client type is classified into a WeChat application client, a Weibo application client, a QQ application client, and a dianping application client according to a name of an application client.

Step 102: The voice play device determines voice play content of the at least one piece of data information according to a specified correspondence between an information type and voice play content and the determined information type of the at least one piece of data information.

Optionally, in step 102, after receiving the data information sent by the network-side device, the voice play device determines whether a voice play mode is enabled.

Optionally, before step 101 or 102, the method may further include: determining that the voice play device is in a voice play mode.

Specifically, a manner in which the voice play device determines whether the voice play mode is enabled includes but is not limited to the following manners:

In a first manner:

whether a headset jack is connected to a headset device is detected; and if it is detected that the headset jack is connected to the headset device, the voice play device determines that the voice play mode is enabled.

In a second manner:

whether a Bluetooth communication mode is enabled is detected; when it is determined that the Bluetooth communication mode is enabled, whether the voice play device is connected to a Bluetooth headset in a Bluetooth manner is further detected; and if it is detected that the voice play device is connected to the Bluetooth headset in the Bluetooth manner, the voice play device determines that the voice play mode is enabled.

In a third manner:

whether a voice play control key is in an enabled state is detected; and if the voice play control key is in an enabled state, the voice play device determines that the voice play mode is enabled.

In a fourth manner:

whether a user of the voice play device wears a headset is detected; and if a result of the detecting is that the user of the voice play device wears the headset, the voice play device determines that the voice play mode is enabled. For example, whether the user of the voice play device wears the headset is perceived by using a sensor in the headset, for example, a light sensor, a pressure sensor, an ear temperature sensor, or a proximity sensor.

It should be noted that, the four determining manners described above may be used together, or may be independently used, which is not limited herein.

Whether the voice play mode in the voice play device is enabled is detected, and when the voice play device determines that the voice play mode is enabled, a voice play operation is performed, which can ensure information play security.

When determining that the voice play mode is not enabled, the voice play device displays the obtained data information in a notification message bar in a form of notification message.

That is, when the voice play mode in the voice play device is not enabled, it is inappropriate to directly play the obtained data information in a voice manner, which easily causes data information leakage. In this case, the obtained data information is processed in a prior-art manner.

Specifically, the specified correspondence between an information type and voice play content may be set by the user of the voice play device according to a habit, or may be determined by means of learning and according to a use habit of the user of the voice play device, which is not limited herein.

Optionally, if the information type of the at least one piece of data information is an SMS message, voice play content corresponding to the SMS message includes at least one of source information or data information content.

The source information in the SMS message type may be at least one of number information for sending the SMS message or name information for sending the SMS message.

Optionally, if the information type of the at least one piece of data information is an application client, voice play content corresponding to the application client includes at least one of source information, a data information keyword, or data information content.

The source information in the application client type may be at least one of application client name information or application client identifier information.

For example, the application client name information is a sohu news application client or a dianping application client.

The keyword in the application client type includes at least one of a subject name of the received data information or information about a contact that sends the data information.

For example, the subject name of the received data information is “xx holds a news conference”; and the information about the contact that sends the data information is a WeChat friend xxx.

Optionally, if the information type of the at least one piece of data information is call information, voice play content corresponding to the call information includes source information.

The source information in the call information may be at least one of communications peer number information or communications peer name information.

Optionally, if the information type of the at least one piece of data information is a system update, voice play content corresponding to the system update includes at least one of source information or update content.

The source information in the system update includes at least one of a hardware identifier or a software identifier in the system update.

Optionally, if the information type of the at least one piece of data information is a text, voice play content corresponding to the text includes at least one of text content or keyword content of text content.

For example, the text content may be a text sent by a friend in a WeChat application client, or text news pushed by a news client.

Optionally, if the information type of the at least one piece of data information is an audio type or a video type, voice play content corresponding to the audio type or the video type includes audio content.

Optionally, if the information type of the at least one piece of data information is an image, voice play content corresponding to the image includes content displayed in the image.

Optionally, if the information type of the at least one piece of data information is a link, voice play content corresponding to the link type includes a link address.

The content displayed in the image is determined in the following manner:

determining a category of an object displayed in the image, where the category of the object includes at least one of a person, scenery, an animal, a plant, or an article;

determining, according to the category of the object and a specified correspondence between the category of the object and a keyword of the object, the keyword corresponding to the object displayed in the image; and

determining the keyword as the content displayed in the image.

Specifically, a manner of determining voice play content of each piece of data information includes but is not limited to:

extracting voice play content of each piece of obtained data information from the data information, for example, directly by using an interface provided by an operating system, or for another example, by using a notification interface (English: Notification API) provided by an Apple iOS operating system or an Android (English: Android) operating system; or completing extraction by using an Apple Notification Center Service (English: Apple Notification Center Service, Abbreviation: ANCS).

Step 103: The voice play device plays the voice play content of the at least one piece of data information in a voice manner.

In step 103, if the at least one piece of data information is at least two pieces of data information, before the voice play content of the at least one piece of data information is played in the voice manner, the method further includes the following steps.

If the at least two pieces of data information are separately data information having different information types, a first voice play order of the at least two pieces of data information is determined according to specified voice play orders of data information having different information types.

In this case, the voice play device plays, in the voice manner according to the first voice play order, voice play content of each of the at least two pieces of data information having different information types.

It should be noted that, “at least two” in “the at least one piece of data information is at least two pieces of data information” means two or greater than two.

For example, the specified voice play orders of data information having different information types are as follows: A voice play order of call-type data information is prior to a voice play order of SMS message-type data information, and the voice play order of the SMS message-type data information is prior to a voice play order of application client-type data information. When the call-type data information, the SMS message-type data information, and the application client-type data information are simultaneously received, the call-type data information is played first, the SMS message-type data information is played next, and the application client-type data information is played finally, according to the specified voice play orders of data information having different information types.

If the at least two pieces of data information have a same information type, a second voice play order of the at least two pieces of data information is determined according to specified voice play orders of data information having a same information type.

In this case, the voice play device plays voice play content of each of the at least two pieces of data information in the voice manner according to the second voice play order.

For example, application client-type data information includes data information (for example, WeChat official information or news information) whose source information is an official account and data information (for example, information sent in WeChat Moments) whose source information is a personal account, and it may be determined in advance that a voice play order of the data information whose source information is the personal account is prior to a voice play order of the data information whose source information is the official account. When multiple pieces of application client-type data information are obtained, first, data information whose source information is personal account information and data information whose source information is official account information are determined; next, the data information whose source information is the personal account information is preferentially played; and finally, the data information whose source information is the official account information is played.

It should be further noted herein that, the specified voice play orders of data information having a same information type may be further voice play orders determined according to a quantity of times of obtaining data information having same source information, and a larger quantity of times indicates a more preferred voice play order of data information having the source information.

If a quantity of information types of the at least two pieces of data information is greater than 1, and a quantity of pieces of data information having a same information type is greater than 1, a second voice play order and a first voice play order of the at least two pieces of data information are respectively determined according to specified voice play orders of data information having a same information type and specified voice play orders of data information having different information types.

In this case, the voice play device plays voice play content of each of the at least two pieces of data information in the voice manner according to the first voice play order and the second voice play order.

It should be noted that, the voice play orders having different information types are set according to a use habit of the user of the voice play device, or are manually set by the user of the voice play device; and the voice play orders of different data information having a same information type are set according to a use habit of the user of the voice play device, or are manually set by the user of the voice play device.

In addition, a basis that the user of the voice play device may preset the voice play orders is a time at which data information is obtained, and voice play content of each piece of the obtained data information is successively played according to the time at which the data information is obtained.

It should be noted that, the foregoing voice play orders may be set according to a use habit of the user of the voice play device, or may be manually set by the user of the voice play device. The voice play orders of data information having different information types and/or the voice play orders of data information having a same information type are identified according to a use habit, and a voice play model can be dynamically established for the user of the voice play device.

For example, when the user of the voice play device receives data information having different information types and/or data information having a same information type, by means of learning, the voice play device records source information or a content keyword of data information that the user immediately or preferentially opens for viewing, or records source information or a content keyword of the data information on which the user stays for a relatively long time; and determines, according to the recorded information, the voice play orders of data information having different information types.

In addition, if the voice play content that is of the data information and is determined in step 102 includes both a text and a link address, and the link address is inserted in the text. In this case, during execution of voice play, entire text content is preferentially played, to ensure coherence of the text content; and then the user of the voice play device is reminded that the following link address further exists.

Optionally, before the voice play content of the at least one piece of data information is played in the voice manner, the method further includes the following steps:

determining, according to a correspondence of source information of the at least one piece of data information, whether the at least one piece of data information is allowed to play; and

playing the voice play content of the at least one piece of data information in the voice manner when determining that the at least one piece of data information is allowed to play; or

when determining that the at least one piece of data information is forbidden to play, prompting, in a manner of ringing or vibrating, with the at least one piece of data information that is forbidden to play.

“Forbidden to play” may be a disturbance-free mode.

The data information sent by the network-side device to the voice play device includes invalid information such as an advertisement SMS message, a junk SMS message, and application client update information, and the user of the voice play device does not need to obtain information content of the information in a timely manner. Therefore, there is no need to immediately perform the voice play operation on the received invalid information. In this case, a correspondence between “forbidden to play” and source information of the data information on which the voice play operation does not need to be immediately performed is established. That is, when receiving the data information that is forbidden to play, the voice play device prompts the user of the voice play device in a specified manner. In this way, even though the user of the voice play device hears an alert tone of a notification message, the voice play operation does not need to be immediately performed on the voice play device. For example, a “beep” tone is used to prompt the user of the voice play device with a fact that currently received data information is the data information that is forbidden to play.

In addition, the data information that is forbidden to play may be locally identified by the voice play device, for example, an identification manner includes an official account, keyword identification, semantic analysis, and image identification, or is determined by means of identification by using an authorized third-party application; or may be identified by the network-side device, for example, the network-side device identifies advertisement information, and identifies fraud information.

For example, for advertisement information or junk information pushed by the network-side device, source information (for example, telephone number information of a sending party) of the advertisement information or the junk information belongs to source information of the data information that is forbidden to play. That is, once identifying that source information of received data information is the source information of the data information that is forbidden to play, the voice play device directly prompts the user of the voice play device in the manner of ringing or vibrating, for example, a “beep” tone.

Optionally, the method further includes the following steps:

when the voice play content of the at least one piece of data information is played in the voice manner, if new data information is obtained, obtaining an information type of the new data information and voice play content of the new data information;

determining a third voice play order of data information being played, to-be-played data information, and the new data information according to the specified voice play orders having different information types and/or the specified voice play orders of data information having a same information type; and

playing voice play content of the data information being played, voice play content of the to-be-played data information, and the voice play content of the new data information in the voice manner according to the determined third voice play order.

Optionally, the method further includes the following step:

marking the data information as read information when voice play ends.

According to the solutions in Embodiment 1 of the present invention, at least one piece of data information is obtained, and an information type of the at least one piece of data information is determined; when it is determined that the voice play device is in a voice play mode, voice play content of the at least one piece of data information is determined according to a specified correspondence between an information type and voice play content and the determined information type of the at least one piece of data information; and the voice play content of the at least one piece of data information is played in a voice manner. In this way, when a voice play device is in a voice play mode, for obtained data information, the voice play device no longer prompts with the obtained data information only in a manner of ringing or vibrating; instead, may play corresponding content according to an information type of the data information, so that a user of the voice play device hears the content of the obtained data information when it is inconvenient to view the obtained data information, which simplifies an operation procedure of the user of the voice play device in a data information obtaining process, enhances an interaction capability of the voice play device, and brings good device experience to the user of the voice play device.

### Embodiment 2

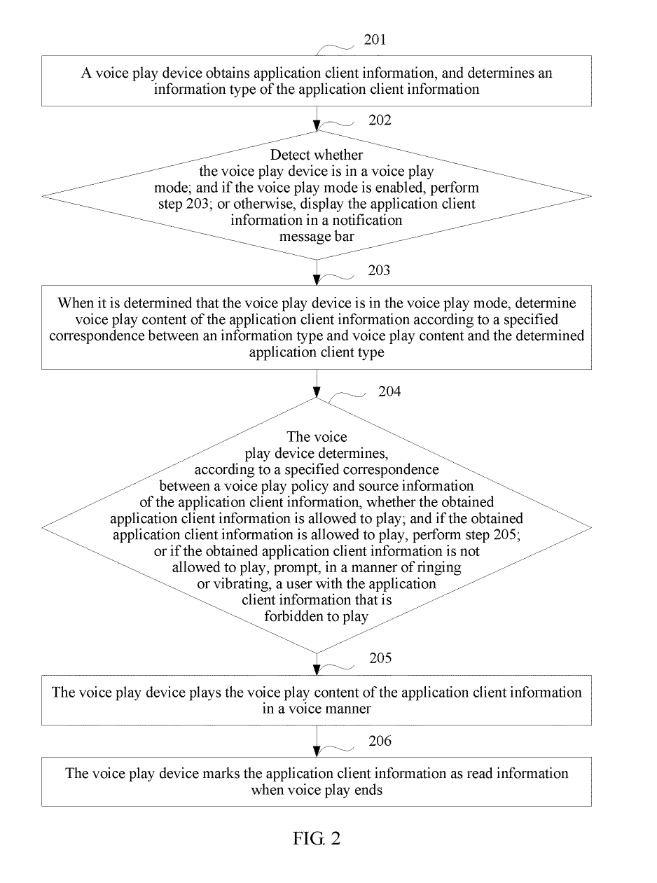

As shown in FIG. 2, FIG. 2 is a schematic flowchart of a voice play method according to Embodiment 2 of the present invention. On a basis of Embodiment 1 of the present invention, an example that received data information is application client-type news information is used for description in Embodiment 2 of the present invention. The method may be described as follows.

Step 201: A voice play device obtains application client information, and determines an information type of the application client information.

The information type of the application client information is an application client type.

Step 202: Detect whether the voice play device is in a voice play mode; and if the voice play mode is enabled, perform step 203; or otherwise, display the application client information in a notification message bar.

Step 203: When it is determined that the voice play device is in the voice play mode, determine voice play content of the application client information according to a specified correspondence between an information type and voice play content and the determined application client type.

In step 203, the voice play content corresponding to the application client includes at least one of source information, a data information keyword, or data information content.

The voice play content of the obtained application client information is extracted from the application client information, for example, directly by using an interface provided by an operating system, or for another example, by using a notification interface (English: Notification API) provided by an Apple iOS operating system or an Android (English: Android) operating system; or extraction is completed by using an Apple Notification Center Service (English: Apple Notification Center Service, Abbreviation: ANCS).

Step 204: The voice play device determines, according to a specified correspondence between a voice play policy and source information of the application client information, whether the obtained application client information is allowed to play; and if the obtained application client information is allowed to play, perform step 205; or if the obtained application client information is not allowed to play, prompt, in a manner of ringing or vibrating, a user with the application client information that is forbidden to play.

It should be noted that, a sequence of performing step 203 and step 204 may be a sequence described in this embodiment, or step 204 may be performed before step 203 is performed, or step 203 and step 204 may be simultaneously performed, which is not limited herein.

In step 204, for example, if the received application client information is “xx news with a headline about a xx news conference”, it is determined that source information of the application client information is news. If a voice play policy corresponding to the news is “to play”, step 205 is performed. If a voice play policy corresponding to the news is “not to play”, the user is prompted, in the manner of ringing or vibrating, with the application client information that is forbidden to play.

Step 205: The voice play device plays the voice play content of the application client information in a voice manner.

Step 206: The voice play device marks the application client information as read information when voice play ends.

According to the solutions in Embodiment 2 of the present invention, when a voice play device is in a voice play mode, for obtained application client information, the voice play device no longer prompts with the obtained application client information only in a manner of ringing or vibrating; instead, may play corresponding content according to an information type of the application client information, so that a user of the voice play device hears the content of the obtained application client information when it is inconvenient to view the obtained application client information, which simplifies an operation procedure of the user of the voice play device in an application client information obtaining process, effectively improves intelligence of converting text data into voice data by the voice play device, enhances an interaction capability of the voice play device, and brings good device experience to the user of the voice play device.

### Embodiment 3

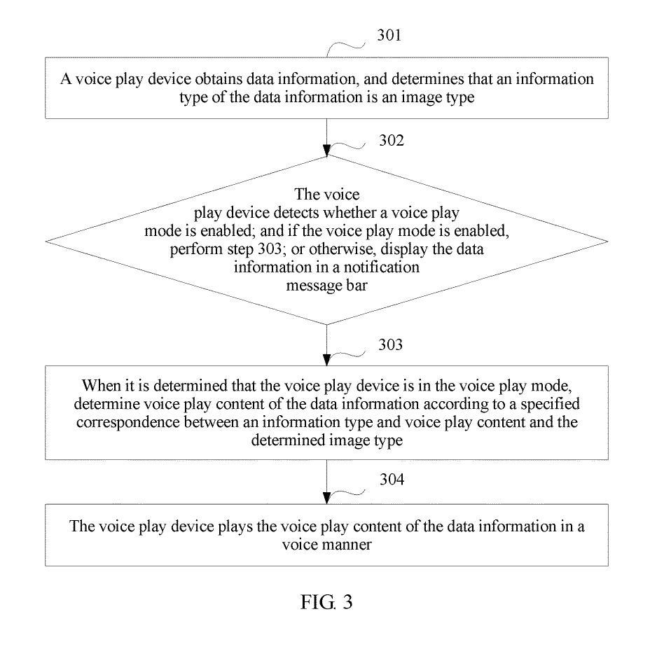

As shown in FIG. 3, FIG. 3 is a schematic flowchart of a voice play method according to Embodiment 3 of the present invention. On a basis of Embodiment 1 of the present invention, an example that obtained data information is image information is used for description in Embodiment 3 of the present invention. The method may be described as follows.

Step 301: A voice play device obtains data information, and determines that an information type of the data information is an image type.

Step 302: The voice play device detects whether a voice play mode is enabled; and if the voice play mode is enabled, perform step 303; or otherwise, display the data information in a notification message bar.

For example, if the data information is sent in a form of multimedia message, the data information is displayed in the notification message bar in the form of multimedia message. If the data information is sent in a form of application client information, in this case, it is determined that the obtained data information sent by a network-side device is application client information.

Step 303: When it is determined that the voice play device is in the voice play mode, determine voice play content of the data information according to a specified correspondence between an information type and voice play content and the determined image type.

In step 303, if the information type of the data information is an image, voice play content corresponding to the image includes content displayed in the image.

Specifically, the content displayed in the image is determined in the following manner:

In the first step, a category of an object displayed in the image is determined.

The category of the object includes at least one of a person, scenery, an animal, a plant, or an article.

Specifically, the image in the obtained data information is segmented, and each part obtained by means of segmentation is analyzed, to determine the category of the object displayed in the image.

For example, it is determined, by analyzing each part obtained by means of segmentation, that the category of the object displayed in the image is scenery.

In the second step, according to the category of the object and a specified correspondence between the category of the object and a keyword of the object, the keyword corresponding to the object displayed in the image is determined.

Specifically, the image displayed in the obtained data information is identified, content described in an image recorded in the image is determined, and then the keyword corresponding to the object displayed in the image is determined according to the specified correspondence between the category of the object and a keyword of the object.

Specifically, image identification may be completed by the voice play device and/or the network-side device. For example, for an image that has a precision requirement for voice play, the image may be sent to the network-side device, and the network-side device obtains, by means of analysis, a more precise keyword corresponding to an object displayed in the image.

For example, a photo of a particular plant in a particular area, a special price image of a particular commodity on a particular website, or a trending graph of a particular stock in a stock market is used, and an object displayed in the image is identified by using an image identification technology.

For example, a keyword corresponding to scenery includes a season. During identification of the image displayed in the obtained data information, it is determined that the content described in the image displayed in the obtained data information is spring scenery, and it is determined, according to the specified correspondence between the category of the object and a keyword of the object, that the keyword corresponding to the object displayed in the image is spring.

A keyword corresponding to a trending graph of a particular stock in a stock market includes a stock name, a stock price, index information, comment information, and the like. The stock name is learned by identifying a text in the trending graph of the stock, whether the trending graph is in a rising trend or in a falling trend is linearly analyzed, and a keyword for play is further obtained by searching for a comment on the stock.

A keyword corresponding to the person category includes who, where, and what. During identification of the image displayed in the obtained data information, it is determined that the content described in the image displayed in the obtained data information is that “XX is eating ZZ at a YY place”, and it is determined, according to the specified correspondence between the category of the object and a keyword of the object, that the keyword corresponding to the object displayed in the image is xx (person), YY (place), and ZZ (what).

When an identity of the person is determined, a local image gallery or a social network may be searched for a profile picture of the person, to obtain a specific name of the person. In addition, the specific name of the person may also be determined according to previously sent chat information. For example, a name of a niece LeLe is determined according to chat information with the niece LeLe.

It should be noted that, if multiple images sent by a network side are received, a keyword of each image may be analyzed, and the keywords obtained by means of analysis are combined, to obtain voice play content.

In the third step, the keyword is determined as the content displayed in the image.

Step 304: The voice play device plays the voice play content of the data information in a voice manner.

According to the solutions in Embodiment 3 of the present invention, when a voice play device is in a voice play mode, for an obtained image, the voice play device no longer prompts with the obtained image only in a manner of ringing or vibrating; instead, may play corresponding content according to an information type of image information, so that a user of the voice play device hears the content of the obtained image when it is inconvenient to view the obtained image, which simplifies an operation procedure of the user of the voice play device in an application client information obtaining process, effectively improves intelligence of converting text data into voice data by the voice play device, enhances an interaction capability of the voice play device, and brings good device experience to the user of the voice play device.

### Embodiment 4

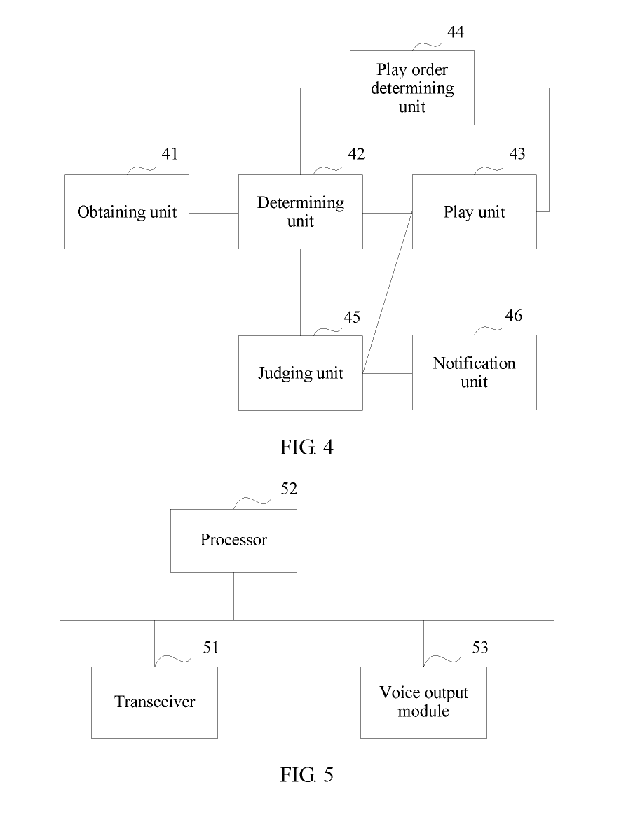

As shown in FIG. 4, FIG. 4 is a schematic structural diagram of a voice play device according to Embodiment 4 of the present invention. The voice play device includes an obtaining unit 41, a determining unit 42, and a play unit 43.

The obtaining unit 41 is configured to obtain at least one piece of data information.

The determining unit 42 is configured to: determine an information type of the at least one piece of data information obtained by the obtaining unit 41, and determine voice play content of the at least one piece of data information according to a specified correspondence between an information type and voice play content and the determined information type of the at least one piece of data information.

The play unit 43 is configured to play the voice play content of the at least one piece of data information in a voice manner.

Optionally, the at least one piece of data information is at least two pieces of data information, and the voice play device further includes a play order determining unit 44.

The play order determining unit 44 is configured to: before the voice play content of the at least one piece of data information is played in the voice manner, if the at least two pieces of data information are separately data information having different information types, determine a first voice play order of the at least two pieces of data information according to specified voice play orders of data information having different information types.

The play unit 43 is specifically configured to play, in the voice manner according to the first voice play order, voice play content of each of the at least two pieces of data information having different information types.

Optionally, the at least one piece of data information is at least two pieces of data information, and the play order determining unit 44 is configured to: if the at least two pieces of data information have a same information type, determine a second voice play order of the at least two pieces of data information according to specified voice play orders of data information having a same information type.

The play unit 43 is specifically configured to play voice play content of each of the at least two pieces of data information in the voice manner according to the second voice play order.

Optionally, the at least one piece of data information is at least two pieces of data information, and the play order determining unit 44 is configured to: before the voice play content of the at least one piece of data information is played in the voice manner, if a quantity of information types of the at least two pieces of data information is greater than 1, and a quantity of pieces of data information having a same information type is greater than 1, respectively determine a second voice play order and a first voice play order of the at least two pieces of data information according to specified voice play orders of data information having a same information type and specified voice play orders of data information having different information types.

The play unit 43 is specifically configured to play voice play content of each of the at least two pieces of data information in the voice manner according to the first voice play order and the second voice play order.

Optionally, the voice play content of the at least one piece of data information includes source information of the at least one piece of data information, and the voice play device further includes a judging unit 45.

The judging unit 45 is configured to: before the voice play content of the at least one piece of data information is played in the voice manner, determine, according to a correspondence of the source information of the at least one piece of data information, whether the at least one piece of data information is allowed to play.

The play unit 43 is specifically configured to play the voice play content of the at least one piece of data information in the voice manner when it is determined that the at least one piece of data information is allowed to play.

Optionally, the voice play device further includes a notification unit 46.

The notification unit 46 is configured to: when it is determined that the at least one piece of data information is forbidden to play, prompt, in a manner of ringing or vibrating, with the at least one piece of data information that is forbidden to play.

Specifically, if the information type of the at least one piece of data information is an SMS message, voice play content corresponding to the SMS message includes at least one of source information or data information content; or

if the information type of the at least one piece of data information is an application client, voice play content corresponding to the application client includes at least one of source information, a data information keyword, or data information content.

Specifically, if the information type of the at least one piece of data information is a text, voice play content corresponding to the text includes at least one of text content or keyword content of text content; or

if the information type of the at least one piece of data information is an audio type or a video type, voice play content corresponding to the audio type or the video type includes audio content; or

if the information type of the at least one piece of data information is an image, voice play content corresponding to the image includes content displayed in the image; or

if the information type of the at least one piece of data information is a link, voice play content corresponding to the link type includes a link address.

Specifically, the content displayed in the image is determined in the following manner:

determining a category of an object displayed in the image, where the category of the object includes at least one of a person, scenery, an animal, a plant, or an article;

determining, according to the category of the object and a specified correspondence between the category of the object and a keyword of the object, the keyword corresponding to the object displayed in the image; and

determining the keyword as the content displayed in the image.

Optionally, the obtaining unit 41 is further configured to: when the voice play content of the at least one piece of data information is played in the voice manner, if new data information is obtained, obtain an information type of the new data information and voice play content of the new data information.

The play order unit 44 is further configured to determine a third voice play order of data information being played, to-be-played data information, and the new data information according to the specified voice play orders having different information types and/or the specified voice play orders of data information having a same information type.

The play unit 43 is configured to play voice play content of the data information being played, voice play content of the to-be-played data information, and the voice play content of the new data information in the voice manner according to the determined third voice play order.

The voice play device in Embodiment 4 of the present invention may be implemented by software, or may be implemented by hardware, and an implementation manner is not limited herein.

### Embodiment 5

As shown in FIG. 5, FIG. 5 is a schematic structural diagram of a voice play device according to Embodiment 5 of the present invention. The voice play device has functions described in Embodiment 1 of the present invention to Embodiment 3 of the present invention. The voice play device may use a structure of a general computer system, and the computer system may be specifically a processor-based computer. The voice play device entity includes a transceiver 51, a processor 52, and a voice output module 53.

The transceiver 51 is configured to obtain at least one piece of data information.

The processor 52 is configured to: determine an information type of the at least one piece of data information, and determine voice play content of the at least one piece of data information according to a specified correspondence between an information type and voice play content and the determined information type of the at least one piece of data information.

The voice output module 53 is configured to play the voice play content of the at least one piece of data information in a voice manner.

Optionally, the at least one piece of data information is at least two pieces of data information, and before the voice output module 53 plays the voice play content of the at least one piece of data information in the voice manner, the processor 52 is further configured to:

if the at least two pieces of data information are separately data information having different information types, determine a first voice play order of the at least two pieces of data information according to specified voice play orders of data information having different information types; and

that the voice output module 53 plays the voice play content of the at least one piece of data information in the voice manner specifically includes:

playing, in the voice manner according to the first voice play order, voice play content of each of the at least two pieces of data information having different information types.

Optionally, the at least one piece of data information is at least two pieces of data information, and before the voice output module 53 plays the voice play content of the at least one piece of data information in the voice manner, the processor 52 is further configured to:

if the at least two pieces of data information have a same information type, determine a second voice play order of the at least two pieces of data information according to specified voice play orders of data information having a same information type; and

that the voice output module 53 plays the voice play content of the at least one piece of data information in the voice manner specifically includes:

playing voice play content of each of the at least two pieces of data information in the voice manner according to the second voice play order.

Optionally, the at least one piece of data information is at least two pieces of data information, and before the voice output module 53 plays the voice play content of the at least one piece of data information in the voice manner, the processor 52 is further configured to:

if a quantity of information types of the at least two pieces of data information is greater than 1, and a quantity of pieces of data information having a same information type is greater than 1, respectively determine a second voice play order and a first voice play order of the at least two pieces of data information according to specified voice play orders of data information having a same information type and specified voice play orders of data information having different information types; and

that the voice output module 53 plays the voice play content of the at least one piece of data information in the voice manner specifically includes:

playing voice play content of each of the at least two pieces of data information in the voice manner according to the first voice play order and the second voice play order.

Optionally, the voice play content of the at least one piece of data information includes source information of the at least one piece of data information, and before the voice output module 53 plays the voice play content of the at least one piece of data information in the voice manner, the processor 52 is further configured to:

determine, according to a correspondence of the source information of the at least one piece of data information, whether the at least one piece of data information is allowed to play; and

that the voice output module 53 plays the voice play content of the at least one piece of data information in the voice manner specifically includes:

playing the voice play content of the at least one piece of data information in the voice manner when it is determined that the at least one piece of data information is allowed to play.

Optionally, the processor 52 is further configured to:

when it is determined that the at least one piece of data information is forbidden to play, prompt, in a manner of ringing or vibrating, with the at least one piece of data information that is forbidden to play.

Specifically, if the information type of the at least one piece of data information is an SMS message, voice play content corresponding to the SMS message includes at least one of source information or data information content; or

if the information type of the at least one piece of data information is an application client, voice play content corresponding to the application client includes at least one of source information, a data information keyword, or data information content.

Specifically, if the information type of the at least one piece of data information is a text, voice play content corresponding to the text includes at least one of text content or keyword content of text content; or

if the information type of the at least one piece of data information is an audio type or a video type, voice play content corresponding to the audio type or the video type includes audio content; or

if the information type of the at least one piece of data information is an image, voice play content corresponding to the image includes content displayed in the image; or

if the information type of the at least one piece of data information is a link, voice play content corresponding to the link type includes a link address.

Specifically, the content displayed in the image is determined in the following manner:

determining a category of an object displayed in the image, where the category of the object includes at least one of a person, scenery, an animal, a plant, or an article;

determining, according to the category of the object and a specified correspondence between the category of the object and a keyword of the object, the keyword corresponding to the object displayed in the image; and

determining the keyword as the content displayed in the image.

Optionally, the processor 52 is further configured to: when the voice play content of the at least one piece of data information is played in the voice manner, if new data information is obtained, obtain an information type of the new data information and voice play content of the new data information; and determine a third voice play order of data information being played, to-be-played data information, and the new data information according to the specified voice play orders having different information types and/or the specified voice play orders of data information having a same information type.

The voice output module 53 is further configured to play voice play content of the data information being played, voice play content of the to-be-played data information, and the voice play content of the new data information in the voice manner according to the determined third voice play order.

It should be noted that, the voice play device in Embodiment 5 of the present invention may be an independent apparatus, or may be integrated into various voice assistant apparatuses. The voice assistant apparatus may be one or more of a set-top box, a mobile phone, a tablet computer (English: Tablet Personal Computer), a laptop computer (English: Laptop Computer), a multimedia player, a digital camera, a personal digital assistant (English: personal digital assistant, Abbreviation: PDA), a navigation apparatus, a mobile Internet apparatus (English: Mobile Internet Device, Abbreviation: MID), or a wearable device (English: Wearable Device).

The processor in this embodiment of the present invention may also be referred to as a processing unit, is connected to each part of the entire voice play device by using various interfaces and lines, and performs various functions of the voice play device and/or processes data by running or executing a software program and/or module stored in a storage unit and invoking data stored in the storage unit. The processor may include an integrated circuit (English: Integrated Circuit, Abbreviation: IC), for example, may include a single packaged IC, or may include multiple connected packaged ICs with a same function or different functions. The processor may include only a central processing unit (English: Central Processing Unit, Abbreviation: CPU), or may be a combination of a GPU, a digital signal processor (English: Digital Signal Processor, Abbreviation: DSP), and a control chip (for example, a baseband chip) in a communications unit. In an implementation manner of the present invention, the CPU may be a single computing core, or may include multiple computing cores.

In this embodiment of the present invention, the voice output module converts a digital signal to a voice signal and outputs the voice signal, and may include an audio processing chip and a speaker, or may include hardware units such as an audio processing chip and a headset.

The transceiver in this embodiment of the present invention may be a component having a function of receiving and sending a wired data signal, or a component (such as a radio frequency chip or an antenna) having a function of receiving and sending a wireless data signal.

In this embodiment of the present invention, an input unit may further be included. The input unit may be various types of sensing components, for example, a Hall component, configured to detect a physical quantity of an electronic device, for example, force, torque, pressure, a stress, a position, displacement, a speed, an acceleration, an angle, an angular velocity, a rotation quantity, a rotational speed, and duration in which a working state changes, and convert the physical quantity into an electric quantity for detection and control. Other sensing components may further include a gravity sensor, a tri-axis accelerometer, a gyroscope, an electronic compass, an ambient light sensor, a proximity sensor, a temperature sensor, a humidity sensor, a pressure sensor, a heart rate sensor, a fingerprint sensor, and the like.

A person skilled in the art should understand that the embodiments of the present invention may be provided as a method, an apparatus (device), or a computer program product. Therefore, the present invention may use a form of hardware only embodiments, software only embodiments, or embodiments with a combination of software and hardware. Moreover, the present invention may use a form of a computer program product that is implemented on one or more computer-usable storage media (including but not limited to a disk memory, a CD-ROM, an optical memory, and the like) that include computer-usable program code.

The present invention is described with reference to the flowcharts and/or block diagrams of the method, the apparatus (device), and the computer program product according to the embodiments of the present invention. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of any other programmable data processing device to generate a machine, so that the instructions executed by a computer or a processor of any other programmable data processing device generate an apparatus for implementing a specific function in one or more processes in the flowcharts and/or in one or more blocks in the block diagrams.

These computer program instructions may also be stored in a computer readable memory that can instruct the computer or any other programmable data processing device to work in a specific manner, so that the instructions stored in the computer readable memory generate an artifact that includes an instruction apparatus. The instruction apparatus implements a specific function in one or more processes in the flowcharts and/or in one or more blocks in the block diagrams.

These computer program instructions may also be loaded onto a computer or another programmable data processing device, so that a series of operations and steps are performed on the computer or the another programmable device, thereby generating computer-implemented processing. Therefore, the instructions executed on the computer or the another programmable device provide steps for implementing a specific function in one or more processes in the flowcharts and/or in one or more blocks in the block diagrams.

Although some preferred embodiments of the present invention have been described, persons skilled in the art can make changes and modifications to these embodiments once they learn the basic inventive concept. Therefore, the following claims are intended to be construed as to cover the preferred embodiments and all changes and modifications falling within the scope of the present invention.

Obviously, a person skilled in the art can make various modifications and variations to the present invention without departing from the spirit and scope of the present invention. The present invention is intended to cover these modifications and variations provided that they fall within the scope of protection defined by the following claims and their equivalent technologies.

1.-30. (canceled)

31. A voice play method, implemented to a voice play device, comprising:
obtaining at least one piece of data information, and determining an information type of the at least one piece of data information;
determining, by the voice play device, voice play content of the at least one piece of data information according to a specified correspondence between an information type and voice play content and the determined information type of the at least one piece of data information; and
playing the voice play content of the at least one piece of data information in a voice manner.

32. The voice play method according to claim 31, wherein the at least one piece of data information is at least two pieces of data information;
before the playing the voice play content of the at least one piece of data information in a voice manner, the method further comprises:
determining a first voice play order of the at least two pieces of data information according to specified voice play orders of data information having different information types when the at least two pieces of data information are separately data information having different information types; and
the playing the voice play content of the at least one piece of data information in a voice manner comprises:
playing, in the voice manner according to the first voice play order, voice play content of each of the at least two pieces of data information having different information types.

33. The voice play method according to claim 31, wherein the at least one piece of data information is at least two pieces of data information;
before the playing the voice play content of the at least one piece of data information in a voice manner, the method further comprises:
determining a second voice play order of the at least two pieces of data information according to specified voice play orders of data information having a same information type when the at least two pieces of data information have a same information type; and
the playing the voice play content of the at least one piece of data information in a voice manner comprises:
playing voice play content of each of the at least two pieces of data information in the voice manner according to the second voice play order.

34. The voice play method according to claim 31, wherein the at least one piece of data information is at least two pieces of data information;
before the playing the voice play content of the at least one piece of data information in a voice manner, the method further comprises:
respectively determining a first voice play order and a second voice play order of the at least two pieces of data information according to specified voice play orders of data information having a same information type and specified voice play orders of data information having different information types when a quantity of information types of the at least two pieces of data information is greater than 1, and a quantity of pieces of data information having a same information type is greater than 1; and
the playing the voice play content of the at least one piece of data information in a voice manner comprises:
playing voice play content of each of the at least two pieces of data information in the voice manner according to the first voice play order and the second voice play order.

35. The voice play method according to claim 31, wherein the voice play content of the at least one piece of data information comprises source information of the at least one piece of data information;
before the playing the voice play content of the at least one piece of data information in a voice manner, the method further comprises:
determining, according to the source information of the at least one piece of data information and a correspondence between a voice play policy and the source information of the at least one piece of data information, whether the at least one piece of data information is allowed to play; and
the playing the voice play content of the at least one piece of data information in a voice manner comprises:
playing the voice play content of the at least one piece of data information in the voice manner when determining that the at least one piece of data information is allowed to play.

36. The voice play method according to claim 35, wherein the method further comprises: when determining that the at least one piece of data information is forbidden to play, prompting, in a manner of ringing or vibrating, a user with the at least one piece of data information that is forbidden to play.

37. The voice play method according to claim 31, wherein voice play content corresponding to an SMS message comprises at least one of source information or data information content when the information type of the at least one piece of data information is an SMS message; or
voice play content corresponding to the application client comprises at least one of source information, a data information keyword, or data information content when the information type of the at least one piece of data information is an application client.

38. The voice play method according to claim 31, wherein
voice play content corresponding to the text comprises at least one of text content or a keyword of text content when the information type of the at least one piece of data information is a text;
voice play content corresponding to the audio type or the video type comprises audio content when the information type of the at least one piece of data information is an audio type or a video type; or
voice play content corresponding to the image comprises content displayed in the image when the information type of the at least one piece of data information is an image; or
voice play content corresponding to the link type comprises a link address when the information type of the at least one piece of data information is a link.

39. The voice play method according to claim 38, wherein the content displayed in the image is determined in the following manner:
determining a category of an object displayed in the image, wherein the category of the object comprises at least one of a person, scenery, an animal, a plant, or an article;
determining, according to the category of the object and a specified correspondence between the category of the object and a keyword of the object, the keyword corresponding to the object displayed in the image; and
determining the keyword as the content displayed in the image.

40. The voice play method according to claim 31, wherein the method further comprises:
when the voice play content of the at least one piece of data information is played in the voice manner, if new data information is obtained, obtaining an information type of the new data information and voice play content of the new data information;
determining a third voice play order of data information being played, to-be-played data information, and the new data information according to the specified voice play orders of data information having different information types and/or the specified voice play orders of data information having a same information type; and
playing voice play content of the data information being played, voice play content of the to-be-played data information, and the voice play content of the new data information in the voice manner according to the determined third voice play order.

41. A voice play device, comprising:
a transceiver, configured to obtain at least one piece of data information;
a processor, configured to: determine an information type of the at least one piece of data information, and determine voice play content of the at least one piece of data information according to a specified correspondence between an information type and voice play content and the determined information type of the at least one piece of data information; and
a voice output module, configured to play the voice play content of the at least one piece of data information in a voice manner.

42. The voice play device according to claim 41, wherein the at least one piece of data information is at least two pieces of data information;
the processor is further configured to:
before the voice output module plays the voice play content of the at least one piece of data information in the voice manner, determine a first voice play order of the at least two pieces of data information according to specified voice play orders of data information having different information types when the at least two pieces of data information are separately data information having different information types; and
the voice output module is configured to:
play, in the voice manner according to the first voice play order, voice play content of each of the at least two pieces of data information having different information types.

43. The voice play device according to claim 41, wherein the at least one piece of data information is at least two pieces of data information;
before the voice output module plays the voice play content of the at least one piece of data information in the voice manner, the processor is further configured to:
determine a second voice play order of the at least two pieces of data information according to specified voice play orders of data information having a same information type if the at least two pieces of data information have a same information type; and
the voice output module is configured to:
play voice play content of each of the at least two pieces of data information in the voice manner according to the second voice play order.

44. The voice play device according to claim 41, wherein the at least one piece of data information is at least two pieces of data information;
the processor is further configured to:
before the voice output module plays the voice play content of the at least one piece of data information in the voice manner, if a quantity of information types of the at least two pieces of data information is greater than 1, and a quantity of pieces of data information having a same information type is greater than 1, respectively determine a second voice play order and a first voice play order of the at least two pieces of data information according to specified voice play orders of data information having a same information type and specified voice play orders of data information having different information types; and
the voice output module is configured to:
play voice play content of each of the at least two pieces of data information in the voice manner according to the first voice play order and the second voice play order.

45. The voice play device according to claim 41, wherein the voice play content of the at least one piece of data information comprises source information of the at least one piece of data information;
the processor is further configured to:
before the voice output module plays the voice play content of the at least one piece of data information in the voice manner, determine, according to a correspondence of the source information of the at least one piece of data information, whether the at least one piece of data information is allowed to play; and
the voice output module is configured to:
play the voice play content of the at least one piece of data information in the voice manner when it is determined that the at least one piece of data information is allowed to play.

46. The voice play device according to claim 45, wherein the processor is further configured to:
when it is determined that the at least one piece of data information is forbidden to play, prompt, in a manner of ringing or vibrating, with the at least one piece of data information that is forbidden to play.

47. The voice play device according to claim 41, wherein
if the information type of the at least one piece of data information is an SMS message, voice play content corresponding to the SMS message comprises at least one of source information or data information content; or
if the information type of the at least one piece of data information is an application client, voice play content corresponding to the application client comprises at least one of source information, a data information keyword, or data information content.

48. The voice play device according to claim 41, wherein
if the information type of the at least one piece of data information is a text, voice play content corresponding to the text comprises at least one of text content or keyword content of text content; or
if the information type of the at least one piece of data information is an audio type or a video type, voice play content corresponding to the audio type or the video type comprises audio content; or
if the information type of the at least one piece of data information is an image, voice play content corresponding to the image comprises content displayed in the image; or
if the information type of the at least one piece of data information is a link, voice play content corresponding to the link type comprises a link address.

49. The voice play device according to claim 48, wherein the processor is configured to:
determine a category of an object displayed in the image, wherein the category of the object comprises at least one of a person, scenery, an animal, a plant, or an article;
determine, according to the category of the object and a specified correspondence between the category of the object and a keyword of the object, the keyword corresponding to the object displayed in the image; and
determine the keyword as the content displayed in the image.

50. The voice play device according to claim 41, wherein
the processor is further configured to: when the voice play content of the at least one piece of data information is played in the voice manner, if new data information is obtained, obtain an information type of the new data information and voice play content of the new data information; and determine a third voice play order of data information being played, to-be-played data information, and the new data information according to the specified voice play orders having different information types and/or the specified voice play orders of data information having a same information type; and
the voice output module is further configured to play voice play content of the data information being played, voice play content of the to-be-played data information, and the voice play content of the new data information in the voice manner according to the determined third voice play order.
